(19) United States
(12) Patent Application Publication
(10) Pub. No.: US 2024/0388318 A1
(43) Pub. Date: Nov. 21, 2024

(54) Mobile-Device Stand

(71) Applicants: Sean Kieley, Montreal (CA); Aleksandr Kliavinsh, Montreal (CA)

(72) Inventors: Sean Kieley, Montreal (CA); Aleksandr Kliavinsh, Montreal (CA)

(73) Assignee: SurfaceID Product Development Corporation, Montreal (CA)

(21) Appl. No.: 18/661,675

(22) Filed: May 12, 2024

Related U.S. Application Data
(60) Provisional application No. 63/503,390, filed on May 19, 2023.

(51) Int. Cl. H04B 1/3877; H04M 1/04

(52) U.S. Cl. CPC H04B 1/3877; H04M 1/04; H04M 2201/08

(57) ABSTRACT

The invention is a mobile-device stand comprising a base with two rotatable folding legs, two arms, and a mobile-mounting fixture operative to magnetically mount a mobile device and, optionally, an accessory subsystem to opposite sides of the mobile-mounting fixture.

This non-provisional application is associated with a previously filed provisional application for essentially the same invention. The provisional application number is 63503390 and was filed on May 19, 2023. That provisional application is hereby incorporated by reference.

### TECHNICAL FIELD

The invention is a system that holds a mobile device on even, or uneven, surfaces without requiring use of hands.

### BACKGROUND OF INVENTION

Today's mobile devices offer myriad features and functions. These devices are relatively small, light-weight devices with touch-screen displays and iconic-display function controls.

Many users spend many hours holding and manipulating these mobile devices, and many users find that the hand holding the device can become cramped, numbed or otherwise uncomfortable.

One way to remediate this discomfort is to use a mobile-device stand operative to hold the device while the stand sits on a horizontal surface, such as a table or desk. In this way, a user may use either hand to control the device, periodically, without having to hold the device for the duration of its use.

Stands have also been designed and produced that attach to a vehicle's dashboard so as to hold the device while it performs navigation-oriented tasks.

Often, users want to take such stands with them when traveling, or using them in mobile contexts such as in bed, in an airplane, in a bus, in a car, but they are not generally designed to be portable and adaptable to varied surfaces.

### BRIEF DESCRIPTION OF INVENTION

The invention herein disclosed and claimed is a mobile-device stand comprising a base portion and two arm portions. The base portion interfaces to a first arm portion through a frictional hinging fixture. The first arm portion interfaces to a second arm portion through a frictional hinging fixture.

At the end of the second arm portion, opposite the end that interfaces with the first arm portion, there is a mobile-device mounting fixture comprising a circular surface with a centered aperture, and has a plurality of small, permanent magnets equally spaced just inside the outer circumference of that circular surface. The poles of each magnetic are on opposite sides of the circular surface.

A plurality of metallic structures, distributed essentially equally around the circle, is adhered to the back side of the mobile device essentially centered on that back surface. The mobile device can then be magnetically attached to the front or back sides of the second arm portion's circular surface. An accessory subsystem could have single or multiple functions such as an induction charging, cooling, lighting, audio speaker, haptic, external memory, power bank, Bluetooth, USB hub, or any combination thereof, for example, whose circular interface dimensions are equal to the circular surface of the second arm portion. The accessory subsystem may have a metallic or magnetic interface of equal dimension to the aforementioned plurality of metallic structures to attach it to one face of the mobile-device mounting fixture at the end of the second arm. As such, it allows one to attach the accessory subsystem to the front or back sides of the second arm portion.

By placing the mobile device's attached plurality of metallic structures against either side of the circular surface of the second arm portion, and placing the accessory subsystem and its metallic or magnetic interface against the opposite side of the circular surface of the second arm portion, the mobile device and the accessory subsystem become affixed to the second arm portion and coupled so as to enable the use of the accessory subsystem with the mobile device.

The magnets embedded in the circular surface of the second arm portion provide sufficient force to keep both the mobile device and accessory subsystem bound to the second arm portion. The mobile device, and/or the accessory subsystem are free to rotate in the plane of the second arm portion's circular surface, allowing it to be rotated a full 360 degrees, and to maintain that rotation position when the user's hand is removed.

The base portion, at an end opposite its frictional hinging portion has a pair of legs that may be folded out from the base in a variety of positions to provide secure support for the mobile-device stand when placed horizontal flat surface. Where the stand will be used with a non-flat surface, these legs may be rotated up to 250 degrees, and may be sufficiently flexible so as to conform to a convex or concave surface. These legs may also be folded back into the base for storage or transport. The frictional hinging fixtures allow the base and two arms to be rotated relative to one another and held in the adjusted position by the frictional force of the frictional hinging fixture.

When preparing to travel with the mobile-device stand, the legs may be rotated back into the base, and the two arms zig-zag folded so as to form a neatly stacked, compact entity that is resistant to damage and takes up much less space.

### BRIEF DESCRIPTION OF DRAWINGS

FIG. 1 shows an embodiment of the invention supporting a mobile device.

FIG. 2 shows the embodiment of FIG. 1 with base and arms.

FIG. 3 illustrates the embodiment of FIG. 1 focused on the structure at one end of an arm.

FIG. 4 illustrates a plurality of metallic structures that adhere to the back side of a mobile device.

FIG. 5 illustrates how a mobile device with the plurality of metallic structures of FIG. 4 in place, and an accessory subsystem with a interface are attached to the structure shown in FIG. 3.

FIG. 6 shows how a mobile device attached as shown in FIG. 5 may be rotated.

FIG. 7 illustrates how the base, arms and legs are folded to facilitate packing of the device taking up minimal space.

FIG. 8 illustrates how the legs may be rotated in the plane of the base, and because they are flexible, may conform to a non-flat surface.

FIG. 9 illustrates how the folding legs can be rotated so as to provide secure support when the stand is placed on the torso of a reclining user.

FIG. 10 illustrates how the folding legs are flexible enough to provide secure support when the stand is place on the thigh of a sitting user.

FIG. 11 shows two views of the stand showing the position versatility afforded by the ability to place the mobile device on either side of the second arm plus the articulation flexibility of the frictional hinging fixtures.

### DETAILED DESCRIPTION OF INVENTION

Hand-held mobile devices have become extremely popular for accessing the Internet, sending and receiving messages and email, making voice calls, and audio/video calls.

When held in a hand for extended periods of time, many users notice that the hand can become cramped or numbed.

Devices designed to hold a mobile device allowing users to avoid prolonged hand holding and discomfort are available. These can be placed on a horizontal flat surface, such as a desk, or mounted to a vehicle's dash board.

The invention herein disclosed and claimed is an improved mobile-device stand, which provides positional versatility and optional in-place use of attached accessory subsystems, complementing a variety of mobile device functions. What's more, it is designed to fold into a very compact form enabling easy packing and transport. And, due to rotatable legs on one end of the base, the stand may be used for non-flat surfaces, as well as flat surfaces.

The stand comprises a base portion and two arm portions. The base portion is comprised of two fold-away legs and a frictional hinging structure that attaches to a mating structure on one end of a first arm.

The first arm has a frictional hinging structure on its opposite end that that attaches to a mating structure on one end of a second arm.

And, the second arm has a mobile-device mounting fixture on the end opposite its frictional hinging structure.

The second arm's mobile-device mounting structure is a circular surface with a centered large aperture. The circular surface has a plurality of small, embedded permanent-magnets arranged in a circle just inside the circular surface's circumference, and oriented such that the magnetic structures are transverse to the plane of the circular surface with their poles on opposite faces of the circular surface.

A mobile device to be mounted on the stand is first outfitted with a plurality of essentially equally distributed, separated, metallic structures. The plurality of metallic structures adheres to the mobile device's rear face and is essentially centered on that face. The metallic interfaced mobile device is then placed such that plurality of metallic structures is adjacent to one of the ring of magnetics, on either side of the circular structure, thereby providing a strong, magnetic-force, adhesion.

Once mounted, the mobile-device may be easily rotated in the plane of its plurality of metallic structures, and will stay in position once rotating is halted.

Accessory subsystems that complement the mobile-device, or may be used in conjunction with the mobile device, may have a similar metallic interface, or a magnetic interface, attached to its circular face, and when placed against the opposite face of the second arm's mobile-device mounting fixture, it, too, will adhere magnetically to that face. As such, the accessory subsystem may function in conjunction with the mobile device. For example, an accessory subsystem that provides induction charging would be properly positioned to enable induction charging of the mobile device, irrespective of any subsequent rotation of the mobile device.

The frictional hinging fixtures that interface the base to the first arm, and the first arm to the second arm, allow adjusting the height of the stand as well as the position of the mobile device with respect to the user. When the legs are unfolded from the base, the two legs and the rear portion of the base form a secure support for the two arms and mounted device and any accessory subsystem. Because the rotatable legs can be rotated to any angle, or folded into the base, and because the legs may be flexible when unfolded, the base may be used with flat surfaces as well as convex or concave surfaces.

Where a user wishes to pack and transport the stand while traveling, the legs fold into the base, and the frictional hinging fixtures enable the arms to be zig-zag folded such that a flat, compact folded-structure is attained.

To make the invention's structure and functions more explicit, the following details and drawings are included. These are exemplary of one embodiment of the invention and should not be read as limiting the scope of claims to these examples.

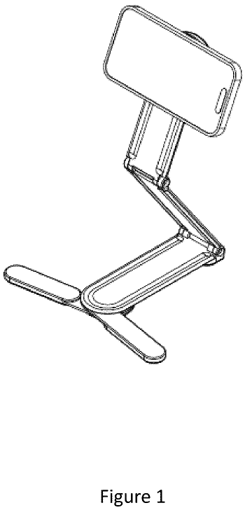

FIG. 1 shows an embodiment of the invention with a mobile device mounted to it. The arms are partially folded to lower the vertical height.

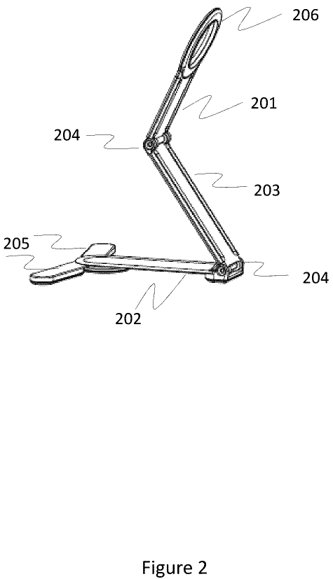

In FIG. 2, the base (202) has an essentially rectangular portion with a frictional hinging fixture (204) on one end, and a pair of legs (205) operative to fold, horizontally, into slots in the rectangular portion. A first arm (203) with mating frictional hinging fixtures on each end interfaces to the base (202) and a second arm (201) with the frictional hinging fixtures as the interfacing elements. At the other end of arm 201, there is a circular surface with a centered aperture (206).

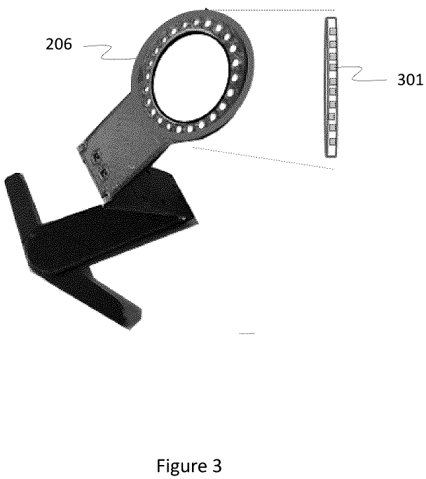

FIG. 3 provides a more detailed view of the circular surface 206. Seen from an edge view, the circular surface has a plurality of embedded permanent-magnets oriented such that the magnet axes are transverse to the plane of the circular surface, and the poles of the magnets are on opposite sides of the circular surface. The circular surface with its aperture and embedded magnets comprises a mobile-device mounting fixture.

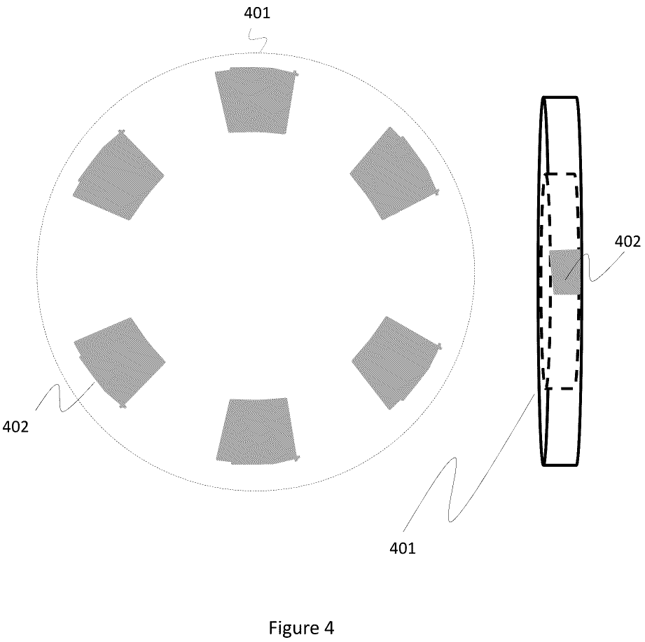

In FIG. 4, a plurality of metallic structures (401) is shown. The separate, equally spaced, metallic structures (402), with an adhesive coating on one side is meant to be attached, essentially centered, to the rear face of a mobile device.

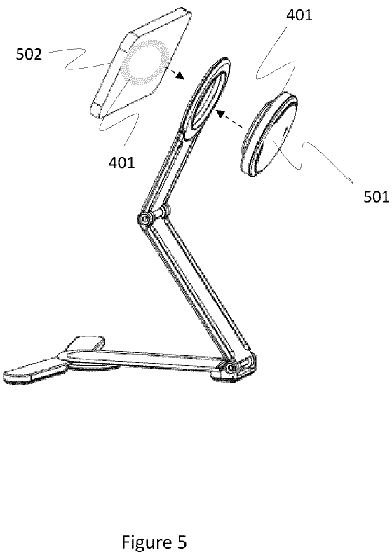

In FIG. 5, a mobile device (502) and an optional accessory subsystem, such as an induction-charging subsystem (501), which has a magnetic, or metallic interface such as 401, can be placed against the opposite side of the circular surface, mobile device mounting fixture, as shown, and will adhere to each face through magnetic force adhesion.

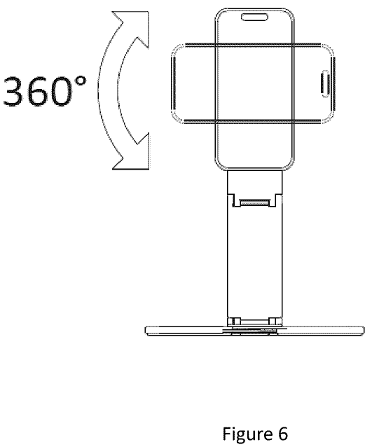

When the mobile device is so mounted to the second arm's circular surface, mobile-device mounting fixture, it is held firmly in place but is free to be rotated, as shown, in FIG. 6. When rotated by hand to any position, once the rotation stops, the mobile device will remain in that position.

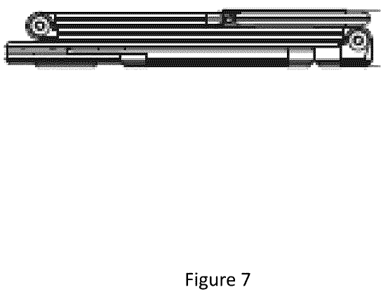

If a user wishes to transport the stand, it may be folded as shown in FIG. 7 producing a very compact assemblage. This is done by folding the legs into slots in the base portion, and zig-zag folding the arms. Prior to folding, the mobile device and induction-charging subsystem would first be removed by pulling each away from the face to which they are magnetically coupled.

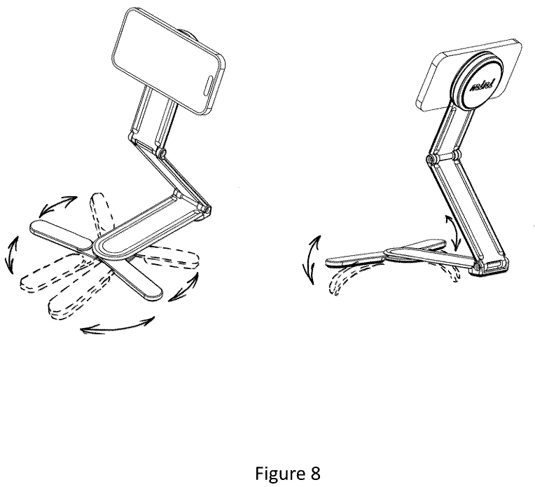

FIG. 8 shows the rotatable legs may be rotated to any angle between 0 and 250 degrees with respect to the base portion, in the same plane as the base portion. Once the legs are folded out of the base portion, they may be sufficiently flexible to conform to a non-flat surface that is either convex or concave.

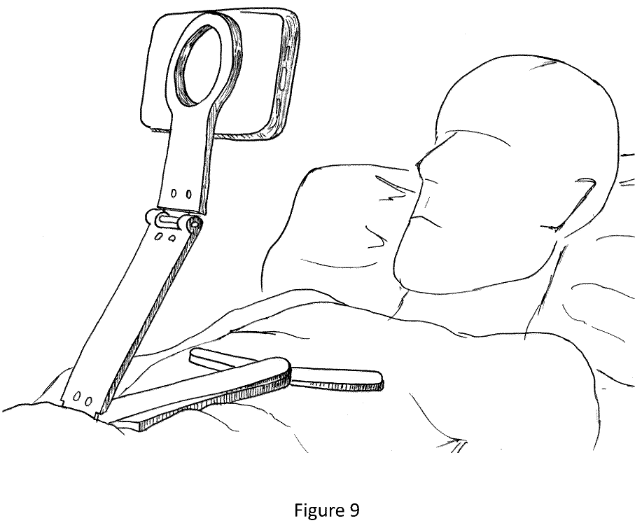

FIG. 9 shows the mobile-device stand set up so as to rest on the torso of a reclining user.

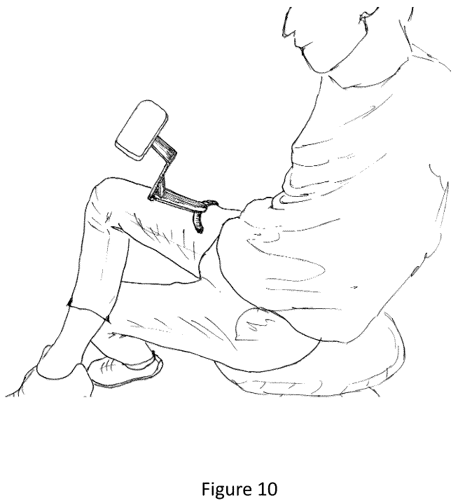

FIG. 10 shows the mobile-device stand set up so as to rest on the thigh of a sitting user.

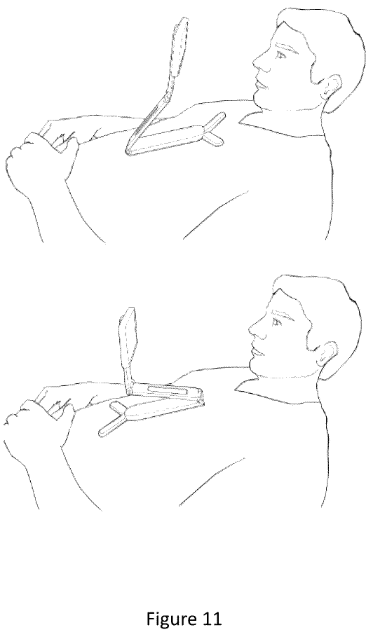

FIG. 11 shows how placement of the mobile device on one face or the other of the stand, reorienting the base of the stand, and using the articulating features supported by the frictional hinging fixtures provides a reclining user with much choice over mobile-device positioning while the stand rests on the user's torso.

The drawings and descriptions, again, are exemplary and depict one embodiment of the invention. The stand base and arms can be made of materials chosen for structural rigidity and light weight. Materials can be metals, plastics and composites.

The magnets embedded in the second arm's circular surface may be cylindrical or polygonal in shape. The frictional hinging fixtures may be any hinging design known in the art.

What is claimed is:

1. A mobile-device stand comprising:
a base portion with at least two folding legs;
a first arm portion with frictional hinging fixtures on each end;
a second arm portion with a frictional hinging fixture on one end and a mobile-device mounting fixture on an opposite end;
the mobile-device mounting fixture comprises a circular surface, with two faces, and a centered aperture; and
the mobile-device mounting fixture comprises embedded permanent magnets arranged in a circle between aperture edge and circular surface edge.

2. A claim as in claim 1 wherein:
the at least two folding legs are operative to fold, horizontally, into slots in the base portion.

3. A claim as in claim 1 wherein:
the first arm interfaces to the base via mating elements of the frictional hinging fixture.

4. A claim as in claim 1 wherein:
the first arm interfaces to the second arm via mating elements of the friction hinging fixture.

5. A mobile-device stand comprising:
a base portion with at least two folding legs;
the first arm portion with frictional hinging fixtures on each end;
the second arm portion with the frictional hinging fixture on one end and the mobile-device mounting fixture on an opposite end;
the mobile-device mounting fixture comprises the circular surface, with two faces, and the centered aperture;
the mobile-device mounting fixture comprises embedded permanent magnets arranged in a circle between aperture edge and circular surface edge; and
an accessory subsystem operative to work in conjunction with the mobile device.

6. A claim as in claim 5 wherein:
the accessory subsystem is operative to interface, magnetically, to one of the two faces of the mobile-device mounting fixture.

7. A claim as in claim 1 further comprising:
a plurality of essentially equally spaced metallic structures is operative to adhere to the rear face of a mobile device.

8. A claim as in claim 5 further comprising:
a metallic interface operative to adhere to the accessory subsystem.

9. A claim as in claim 5 further comprising:
a magnetic interface operative to adhere to the accessory subsystem.
